(19) United States
(12) Patent Application Publication
(10) Pub. No.: US 2025/0219877 A1
(43) Pub. Date: Jul. 3, 2025

(54) METHOD AND DEVICE FOR DETERMINING SYMBOL SIGNALS BASED ON EXPECTED ERRORS DUE TO NARROWBAND INTERFERENCE

(71) Applicant: VSI Co. Ltd., Seoul (KR)

(72) Inventors: Suwon Kang, Gyeonggi-do (KR); Jinbae Park, Gyeonggi-do (KR)

(73) Assignee: VSI Co. Ltd., Seoul (KR)

(21) Appl. No.: 18/979,987

(22) Filed: Dec. 13, 2024

(30) Foreign Application Priority Data
Dec. 27, 2023 (KR) 10-2023-0193352

(51) Int. Cl. H04L 25/49; H04L 25/03

(52) U.S. Cl. CPC H04L 25/4917; H04L 25/03012; H04L 25/03961

(57) ABSTRACT

A device includes delay units connected in a chain, each delaying the equalized symbol signals by a unit time and outputting the delayed signals, a determiner configured such that the symbol level for the current symbol signal inputted from a final stage delay unit of the delay units is determined as one of the predetermined symbol levels at which a minimum error sum is obtained from possible error sums of a current error calculated for the current symbol signal and a predicted error calculated for next discrete symbol signals following the current symbol signal, wherein the current error is a difference value between the current symbol signal and the specified symbol level of the compensated first signal, and the predicted error is a difference value between the predetermined symbol level of the compensated second signal and each of the next discrete symbol signals.

### PRIORITY CLAIM

This application claims priority to Korean Patent Application No. 10-2023-0193352,filed Dec. 27, 2023.

### TECHNICAL FIELD

The present invention relates to a technology for processing a signal received through a transmission channel, and more specifically, to a technology for recovering a received signal by removing the effects of narrowband interference caused by a signal flowing in from other wired or wireless communication channels or devices.

### BACKGROUND

In order to accurately recover transmitted digital data from signals received through a transmission channel, various technologies are applied to a receiver. A typical technology is to equalize signals received from a transmission channel.

However, signal interference due to unexpected factors may occur in the transmission channel. Since such signal interference is not confirmed in advance due to the characteristics of the transmission channel, signal compensation by an equalizer is impossible. Therefore, a separate method is required to eliminate the effects of interference components that are unexpectedly flowed into the transmission channel.

Interference components that are unexpectedly flowed into a transmission channel are usually caused by RF signals that are randomly generated in wired or wireless communication lines or are caused by coupling with arbitrary electrical components, and these have a relatively narrow band when viewed from the perspective of a transmission channel that supports high-speed communication. Due to this characteristic, signal interference in a transmission channel caused by an inflowing RF signal is called narrowband interference (NBI).

FIG. 1 shows the effect when such narrowband interference (hereinafter, referred to as a ‘tone’ in this specification) occurs, which shows the signal levels of the transmitted symbol signals and the received symbol signals recovered through the equalizer, and assumes that four types of information, i.e., two bits of information, are mapped to one symbol.

As illustrated, before the tone occurs (S_{NOR}), there is almost no difference in signal level between the transmitted symbol and its received symbol signal, which means that in a slicer that determines one of four symbol levels for the received symbol signal, the symbol level corresponding to the transmitted symbol is determined from the received symbol signal, so that the 2 bits mapped to the transmitted symbol are accurately decoded.

However, when a tone occurs in the transmission channel (S_{NBI}), the received symbol signals are distorted from the specified symbol level and becomes distributed in the boundary area between symbol levels. In such boundary region symbol signals, a signal is generated, which is determined to have a symbol level different from that of the corresponding transmitted symbol by a slicer that determines the symbol level of the received symbol signal, and therefore a decoding error occurs.

In order to suppress such decoding errors due to tones, a method has been proposed for removing tone components from a received symbol signal. This method is a method for extracting a tone component from an error component determined in a symbol level determination of a previous received symbol signal, and determining a corresponding symbol level based on a signal level obtained by subtracting the extracted tone component from the current reception symbol signal, and the receiver includes a configuration as illustrated in FIG. 2.

The tone removal unit 10 illustrated in the configuration of FIG. 2 includes an error filter 13. In the equalized reception symbol signal outputted from the equalizer 11, the error signals obtained by subtracting the symbol level determined for the preceding reception symbol signal from the slicer 12 are filtered in a predetermined manner to output the interference component value (εₙ₋₁) corresponding to the tone component.

Therefore, the slicer 12 of FIG. 2 receives input of a compensated signal (Vₙ) from which the interference component value (εₙ₋₁) is subtracted from the received symbol signal (dₙ) for which the current symbol level must be determined, and then determines the symbol level closest to this compensated signal. The symbol level determination method of the slicer 12 according to the addition of the tone removal unit 10 is expressed by the following mathematical equation 1.

$${V}_{n} = arg min ( \vert {V}^{j} - {v}_{n} ) , {v}_{n} = {d}_{n} - {ε}_{n - 1} \qquad [ Mathematical Equation 1 ]$$

In the equation, j is an index for the symbol level determined by the slicer 12, and V^{j} represents the level of symbol j. Assuming the example of FIG. 1, j□{0,1,2,3}. arg min( ) means a function that selects the value of V^{j} when the argument is minimum. And, the interference component value (εₙ₋₁) output by the error filter 13 may be the error value (eₙ₋ᵢ) at that point in time, or the average or weighted average of several error values.

The tone removal unit 10 of the configuration illustrated in FIG. 2 can compensate for the signal distortion caused by the tone to some extent by extracting interference components that affect the current reception symbol signal from the error values obtained from the previous symbol level determination and removing the components. However, the method according to Mathematical Equation 1 still has limitations.

When the frequency band of the distorted signal that generates the tone exceeds a certain ratio to the frequency band of the received signal, there are increasing cases where the interference component value outputted by the error filter from the error values obtained from the determination of the previous symbol levels differs from the tone component actually added to the current reception symbol signal that determines the symbol level to such an extent that it leads to an error in determining the symbol level.

### DETAILED DESCRIPTION OF THE INVENTION

### Technical Problem

It is an object of the present disclosure to provide a method for determining symbol signals based on a predicted error due to narrowband interference, which analyzes the tone influence of subsequent received symbol signals together with the received symbol signal to determine the symbol level.

It is another object of the present disclosure to provide a method for determining symbol signals based on a predicted error due to narrowband interference, whereby the symbol level determination method can be adapted to the characteristics of the tones affecting the transmission channel.

The object of the present invention is not limited to the object explicitly stated above, and of course includes the purpose of achieving effects that can be derived from the following specific and exemplary description of the present invention.

### Technical Solution

According to an aspect of the present invention, there is provided a device that determines the level of symbol signals received and equalized through a transmission channel, the device comprising: one or more delay units connected in a chain to each other, each delaying the equalized symbol signals by a unit time and outputting the delayed signals; a determiner configured such that the symbol level for the current symbol signal inputted from a final stage delay unit of the one or more delay units is determined as one of the predetermined symbol levels at which a minimum error sum is obtained from possible error sums of a current error calculated for the current symbol signal and a predicted error calculated for one or more next discrete symbol signals following the current symbol signal, wherein the current error is a difference value between the current symbol signal and the specified symbol level of the compensated first signal, and the predicted error is a difference value between the predetermined symbol level of the compensated second signal and each of one or more next discrete symbol signals, and wherein the second signal is determined at each of the predetermined symbol levels with respect to the symbol signal just before the corresponding next discrete symbol signal.

In an embodiment according to the present invention, the determiner comprises a plurality of calculators configured such that a number (=L^{N}) of current errors corresponding to the N power of the number L of predetermined symbol levels are added to the predicted error to output one of the possible error sums, and a selector configured such that the possible error sums outputted from each of the plurality of calculators are compared with each other to select one from the predetermined symbol levels. Wherein, N is the number of one or more next discrete symbol signals plus 1, and in each of the plurality of calculators, the N specified symbol levels belonging to one of the symbol level combinations created by selecting the already specified symbol levels N times are used in calculating the current error and the predicted error. In the present embodiment, the calculators may be configured such that a first compensation value used for compensating the current symbol signal to obtain a first signal is used to obtain the second compensation value used for compensating the one or more next discrete symbol signals to obtain a second signal. Alternatively, the calculators may be configured such that the first compensation value used for compensating the current symbol signal to obtain the first signal, and the second compensation value used for compensating the one or more next discrete symbol signals to obtain the second signal are obtained from one or more discrete difference values corresponding to the difference from the determined symbol level of one or more discrete symbol signals inputted before the current symbol signal. In this case, the calculators may be configured such that the second compensation value is calculated from a partial discrete difference value excluding the current difference value from the one or more discrete difference values used to obtain the first compensation value, and a current difference value obtained by subtracting one of the specified symbol levels from the current symbol signal. In addition, the calculators may be configured such that the first compensation value is calculated from a weighted average of the one or more discrete difference values, and the second compensation value is calculated from a weighted average of the partial discrete difference values and the current difference value, wherein the weight applied to the current difference value and the weight applied to the current difference value may be the same.

In an embodiment according to the present invention, the determiner comprises a plurality of first error calculators configured to calculate the current error, each of which is provided in the same number as the number L of the specified symbol levels, a plurality of second error calculators configured such that the L number of predicted errors provided corresponding to each of the first error calculators are calculated, and the predicted errors are added to the current errors calculated by the corresponding first error calculators to output one of the possible error sums, and a selector configured such that the possible error sums outputted from each of the calculators are compared with each other to select one from the predetermined symbol levels. And, in each of the first error calculators and the second error calculators, one symbol level of the specified symbol levels is used for calculating the current error or the predicted error. In the present embodiment, the determiner may further comprise a plurality of third error calculators configured such that the L number of second error calculators are provided corresponding to the second error calculators, and each of the L units generates another predicted error and adds the current error and predicted error calculated by the first error calculator and the second error calculator which correspond hierarchically, to output one of possible error sums.

In an embodiment according to the present invention, the determiner is configured such that a difference value between the current symbol signal and one of the predetermined symbol levels is used to obtain a second compensation value for use in compensating one or more next discrete symbol signals to obtain a second signal.

In an embodiment according to the present invention, the compensation is performed by a method of canceling, for each of one or more discrete symbol signals inputted before a compensation target symbol signal, an interference component obtained from a difference value between the corresponding discrete symbol signal and a specified symbol level determined for the corresponding discrete symbol signal, from the compensation target symbol signal. The determiner may be configured to apply a weighted average obtained by individually applying weights to one or more of the difference values as the interference component. In the present embodiment, the determiner may further comprise a controller configured to check the fluctuation rate of the difference value and change and apply the weight according to the checked fluctuation rate. And, the controller is further configured to change the weight applied to the difference value obtained for the discrete symbol signal just before the compensation target symbol signal to a higher value when the fluctuation rate is high compared to when the fluctuation rate is low.

In an embodiment according to the present invention, the determiner is further configured to multiply the current error by the weights respectively assigned to the one or more predicted errors to obtain a sum. And, the weights are assigned relatively larger values as they are multiplied by the error obtained for a discrete symbol signal that is closer in time to the current symbol signal.

In an embodiment according to the present invention, the determiner comprises a single filter root including at least one delay unit, which is configured to receive input of a difference value from a specified symbol level determined for each of one or more discrete symbol signals inputted before the current symbol signal, and configured to output a first compensation value used for compensating the current symbol signal to obtain the first signal, a plurality of filter leaves configured to obtain a second compensation value used for compensating the one or more difference discrete symbol signals to obtain the second signal. Wherein, the filter root is configured to multiply a series of discrete difference values generated by the at least one delay unit by each of the assigned sets of weights, and output a plurality of weighted sum values including the first compensation value. In the present embodiment, the plurality of filter leaves are configured such that at least one signal, which is obtained by subtracting one of the predetermined symbol levels from the next discrete symbol signal excluding the current next discrete symbol signal from the one or more next discrete symbol signals, and at least one symbol signal selected from the current symbol signal, and one of the weighted sum values excluding the first compensation value among the plurality of weighted sum values is weighted and summed, and outputted as the second compensation value.

According to another embodiment according to the present invention, there is provided a method for determining a level of a symbol signal received and equalized through a transmission channel, the method comprising: a step of delaying an equalized symbol signal by a unit time, a step of calculating possible error sums for the current error calculated for the delayed symbol signal and the predicted error calculated for the delayed one or more next discrete symbol signals after the delayed symbol signal, with respect to the symbol level of the delayed symbol signal, and a step of determining one of the predetermined symbol levels, from which the minimum error sum is obtained from the calculated possible error sums, as the symbol level of the delayed symbol signal.

### Advantageous Effects

According to at least one embodiment of the present invention described above or described in detail below with the accompanying drawings, a method for determining symbol signals based on a predicted error checks the influence of the tones before and after it in time on the received symbol signal together and determines its symbol level, thereby more accurately compensating for the distortion of the current received signal caused by the tones generated in the transmission channel, and greatly improving the accuracy of transmitted symbol recovery.

In addition, in an embodiment according to the present invention, the estimation of the compensation signal to cancel the tone is adapted to the characteristics of the tone flowed into the transmission channel, and thus optimal signal compensation is achieved for the tone that frequently occurs in the communication environment provided with the transmission channel.

### BRIEF DESCRIPTION OF THE DRAWINGS

FIG. 1 illustrates the symbol level determination results when narrowband interference occurs in a transmission channel.

FIG. 2 illustrates the configuration of a receiver for removing narrowband interference.

FIG. 3 is a block diagram illustrating a part of the configuration of a receiver to which a method for determining a symbol level based on error due to narrowband interference is applied according to an embodiment of the present invention.

FIGS. 4 and 5 are schematic diagrams illustrating symbol level determination method according to an embodiment of the present invention as to respective cases of encoding a single bit and 2 bits as a symbol.

FIG. 6 illustrates the configuration for a correlated error filter that outputs an inputted error signal as it is according to an embodiment of the present invention.

FIGS. 7a and 7b are block diagrams illustrating the configuration of a c current correlated error filter of FIG. 3 according to other embodiments of the present invention.

FIGS. 8a and 8b are block diagrams illustrating the configuration of a next correlated error filter according to other embodiments of the present invention,

FIGS. 9 and 10 are block diagrams illustrating the configuration of a symbol level determiner according to other embodiments of the present invention.

FIG. 11 illustrates related components that dynamically set coefficients of a correlated error filter in accordance with the characteristics of narrowband interference according to an embodiment of the present invention.

FIG. 12 is a block diagram of an error sum calculator configured to calculate values for predicted errors up to two time units together according to an embodiment of the present invention.

FIG. 13 schematically illustrates that a symbol level for a received symbol signal is determined by a symbol level determiner to which the error sum calculator of FIG. 12 is applied.

FIG. 14 illustrates the configuration of a predicted error sum calculator capable of calculating values for predicted errors up to two time units according to another embodiment of the present invention.

FIGS. 15a to 15c illustrate examples of other configurations of correlated error filters applied to calculating error sums according to another embodiment of the present invention.

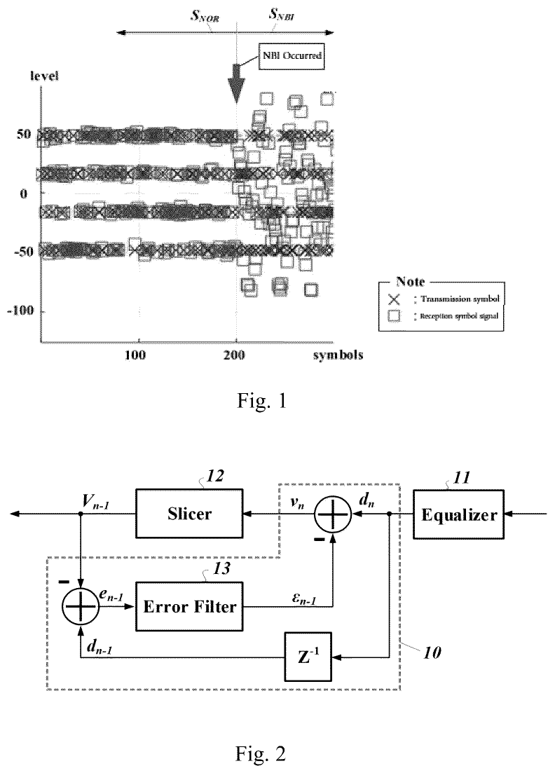

### SUMMARY

An aspect provides a device that determines the level of symbol signals received and equalized through a transmission channel, the device comprising: one or more delay units connected in a chain to each other, each delaying the equalized symbol signals by a unit time and outputting the delayed signals; a determiner configured such that the symbol level for the current symbol signal inputted from a final stage delay unit of the one or more delay units is determined as one of the predetermined symbol levels at which a minimum error sum is obtained from possible error sums of a current error calculated for the current symbol signal and a predicted error calculated for one or more next discrete symbol signals following the current symbol signal, wherein the current error is a difference value between the current symbol signal and the specified symbol level of the compensated first signal, and the predicted error is a difference value between the predetermined symbol level of the compensated second signal and each of one or more next discrete symbol signals, and wherein the second signal is determined at each of the predetermined symbol levels with respect to the symbol signal just before the corresponding next discrete symbol signal.

An aspect as in the previous paragraph provides a device, wherein the determiner comprises, a plurality of calculators configured such that a number (=L^{N}) of current errors corresponding to the N power of the number L of predetermined symbol levels are added to the predicted error to output one of the possible error sums, and a selector configured such that the possible error sums outputted from each of the plurality of calculators are compared with each other to select one from the predetermined symbol levels, N is the number of one or more next discrete symbol signals plus 1, and in each of the plurality of calculators, the N specified symbol levels belonging to one of the symbol level combinations created by selecting the already specified symbol levels N times are used in calculating the current error and the predicted error.

An aspect as in one of the previous two paragraphs provides a device, wherein the calculators are configured such that a first compensation value used for compensating the current symbol signal to obtain a first signal is used to obtain the second compensation value used for compensating the one or more next discrete symbol signals to obtain a second signal.

An aspect as in one of the previous three paragraphs provides a device, wherein the calculators are configured such that the first compensation value used for compensating the current symbol signal to obtain the first signal, and the second compensation value used for compensating the one or more next discrete symbol signals to obtain the second signal are obtained from one or more discrete difference values corresponding to the difference from the determined symbol level of one or more discrete symbol signals inputted before the current symbol signal.

An aspect as in one of the previous four paragraphs provides a device, wherein the calculators are configured such that the second compensation value is calculated from a partial discrete difference value excluding the current difference value from the one or more discrete difference values used to obtain the first compensation value, and a current difference value obtained by subtracting one of the specified symbol levels from the current symbol signal.

An aspect as in one of the previous five paragraphs provides a device, wherein the calculators are configured such that the first compensation value is calculated from a weighted average of the one or more discrete difference values, and the second compensation value is calculated from a weighted average of the partial discrete difference values and the current difference value, wherein the weight applied to the current difference value and the weight applied to the current difference value are the same.

An aspect as in one of the previous six paragraphs provides a device, wherein the determiner comprises, a plurality of first error calculators configured to calculate the current error, each of which is provided in the same number as the number L of the specified symbol levels, a plurality of second error calculators configured such that the L number of predicted errors provided corresponding to each of the first error calculators are calculated, and the predicted errors are added to the current errors calculated by the corresponding first error calculators to output one of the possible error sums, and a selector configured such that the possible error sums outputted from each of the calculators are compared with each other to select one from the predetermined symbol levels, wherein in each of the first error calculators and the second error calculators, one symbol level of the specified symbol levels is used for calculating the current error or the predicted error.

An aspect as in one of the previous seven paragraphs provides a device, wherein the determiner further comprises a plurality of third error calculators configured such that the L number of second error calculators are provided corresponding to the second error calculators, and each of the L units generates another predicted error and adds the current error and predicted error calculated by the first error calculator and the second error calculator which correspond hierarchically, to output one of possible error sums.

An aspect as in one of the previous eight paragraphs provides a device, wherein the determiner is configured such that a difference value between the current symbol signal and one of the predetermined symbol levels is used to obtain a second compensation value for use in compensating one or more next discrete symbol signals to obtain a second signal.

An aspect as in one of the previous nine paragraphs provides a device, wherein the compensation comprises canceling, for each of one or more discrete symbol signals inputted before a compensation target symbol signal, an interference component obtained from a difference value between the corresponding discrete symbol signal and a specified symbol level determined for the corresponding discrete symbol signal, from the compensation target symbol signal.

An aspect as in one of the previous ten paragraphs provides a device, wherein the determiner is configured to apply a weighted average obtained by individually applying weights to one or more of the difference values as the interference component.

An aspect as in one of the previous eleven paragraphs provides a device, wherein the determiner further comprises a controller configured to check the fluctuation rate of the difference value and change and apply the weight according to the checked fluctuation rate, and the controller is further configured to change the weight applied to the difference value obtained for the discrete symbol signal just before the compensation target symbol signal to a higher value when the fluctuation rate is high compared to when the fluctuation rate is low.

An aspect as in one of the previous twelve paragraphs provides a device, wherein the determiner is further configured to multiply the current error by the weights respectively assigned to the one or more predicted errors to obtain a sum, wherein the weights are assigned relatively larger values as they are multiplied by the error obtained for a discrete symbol signal that is closer in time to the current symbol signal.

An aspect as in one of the previous thirteen paragraphs provides a device, wherein the determiner comprises, a single filter root including at least one delay unit, which is configured to receive input of a difference value from a specified symbol level determined for each of one or more discrete symbol signals inputted before the current symbol signal, and configured to output a first compensation value used for compensating the current symbol signal to obtain the first signal, a plurality of filter leaves configured to obtain a second compensation value used for compensating the one or more difference discrete symbol signals to obtain the second signal, wherein the filter root is configured to multiply a series of discrete difference values generated by the at least one delay unit by each of the assigned sets of weights, and output a plurality of weighted sum values including the first compensation value, wherein the plurality of filter leaves are configured such that at least one signal, which is obtained by subtracting one of the predetermined symbol levels from the next discrete symbol signal excluding the current next discrete symbol signal from the one or more next discrete symbol signals, and at least one symbol signal selected from the current symbol signal, and one of the weighted sum values excluding the first compensation value among the plurality of weighted sum values is weighted and summed, and outputted as the second compensation value.

According to an aspect, there is provided a method for determining a level of a symbol signal received and equalized through a transmission channel, the method comprising: a step of delaying an equalized symbol signal by a unit time, a step of calculating possible error sums for the current error calculated for the delayed symbol signal and the predicted error calculated for the delayed one or more next discrete symbol signals after the delayed symbol signal, with respect to the symbol level of the delayed symbol signal, and a step of determining one of the predetermined symbol levels, from which the minimum error sum is obtained from the calculated possible error sums, as the symbol level of the delayed symbol signal, wherein the current errors are respective difference values between the first signal compensated for the delayed symbol signal and the specified symbol levels, and the specified errors are difference values between the second signal compensated for each of the one or more next discrete symbol signals and the specified symbol levels, and the specified second signals are a plurality of signals created by determining the symbol signal just before the next discrete symbol signal as each of the specified symbol levels.

### DETAILED DESCRIPTION OF THE EMBODIMENTS

Hereinafter, various embodiments of the present invention will be described in detail with reference to the accompanying drawings.

In the following description of embodiments according to the present invention and the accompanying drawings, the same numbers denotes the same components unless specified otherwise. Of course, for convenience of explanation and easy of understanding, the same components may also be denoted by different numbers, if necessary.

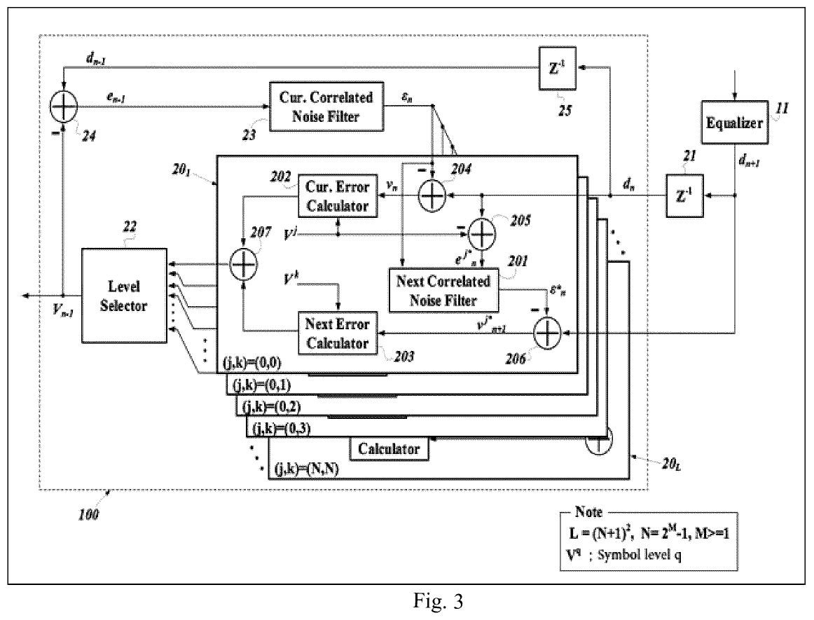

FIG. 3 is a block diagram illustrating a part of the configuration of a receiver to which a method for determining a symbol level based on error due to narrowband interference is applied according to an embodiment of the present invention. The illustrated receiver comprises a normal equalizer 11, a first delay unit 21 that delays an inputted reception symbol signal dₙ₊₁ by a unit time, and a symbol level determiner 100 that receives a reception symbol signal dₙ₊₁, which is a digital signal equalized by an equalizer 11, together with a reception symbol signal dₙ delayed by a unit time by the first delay unit 21, and determines a symbol level for the delayed reception symbol signal dₙ.

And, the symbol level determiner 100 is configured to include: a second delay unit 25 that delays the output signal of the first delay unit 21 by a unit time again, a main adder 24 that subtracts the determined symbol level from the delay symbol signal dₙ₋₁ outputted from the second delay unit 25 and outputs an error signal eₙ₋₁ corresponding to an error due to a tone, a current correlated error filter 23 that receives input of the error signal eₙ₋₁ outputted from the main adder 24, filters it in accordance with a predetermined method, and outputs it as a main interference value εₙ, a plurality of error sum calculators 20ᵢ (i=1, . . . , L) that receive input of an estimated interference value εₙ, a received symbol signal dₙ₊₁, and a delayed symbol signal dₙ, and calculate the difference between the received symbol signal with the estimated tone component canceled and the symbol level specified respectively, and a level selector 22 that determines the symbol level Vₙ for the reception symbol signal dₙ just before the input reception symbol signal dₙ₊₁ from the error sum that is the minimum of the error sums calculated from each of the plurality of error sum calculators 20i.

The error sum calculated by each error sum calculator 20ᵢ corresponds to one of the possible error sums that can be obtained depending on which symbol level is considered for the inputted reception symbol signal dₙ₊₁ and the reception symbol signal dₙ just before it.

The error sum calculator 20ᵢ comprises a first adder 204 that subtracts an estimated interference value εₙ from the inputted reception symbol signal dₙ delayed by a unit time and outputs it, a current error calculator 202 that calculates the difference between the signal outputted from the first adder 204 and the current applied symbol level V^{j} specified for the corresponding error sum calculator, a second adder 205 that subtracts the current applied symbol level V^{j} from the inputted reception symbol signal dₙ delayed by a unit time and outputs it, a next correlated error filter 201 that receives input of the estimated interference value εₙ and the signal outputted from the second adder 205, filters them in accordance with a predetermined method, and outputs a conditional interference value εₙ, a third adder 206 that subtracts the conditional interference value εₙ from the inputted reception symbol signal dₙ₊₁ and outputs it, a next error calculator 203 that calculates the difference between the signal outputted from the third adder 206 and the next applied symbol level V^{k} specified for the corresponding error sum calculator, and a fourth adder 207 that sums up the difference values calculated from the current error calculator 202 and the next error calculator 203, i.e., the current error and the predicted error, and outputs the sum.

The number (L=(2^{M)2}) of the plurality of error sum calculators 20ᵢ is determined by the number of bits M encoded as one symbol. For example, if applied to a receiver that encodes 2 bits as a single symbol and communicates, 16 error sum calculators are provided, and for the current applied symbol level V^{j} and the next applied symbol level V^{k} of each error sum calculator, one of the four symbol levels V⁰, V¹, V², and V³ by 2 bits is selected and applied.

Hereinafter, a method for determining the corresponding symbol level by checking the tone influence on the reception symbol signal after the current reception symbol signal, which is performed in the symbol level determiner 100 whose configuration is illustrated in FIG. 3, is specifically described.

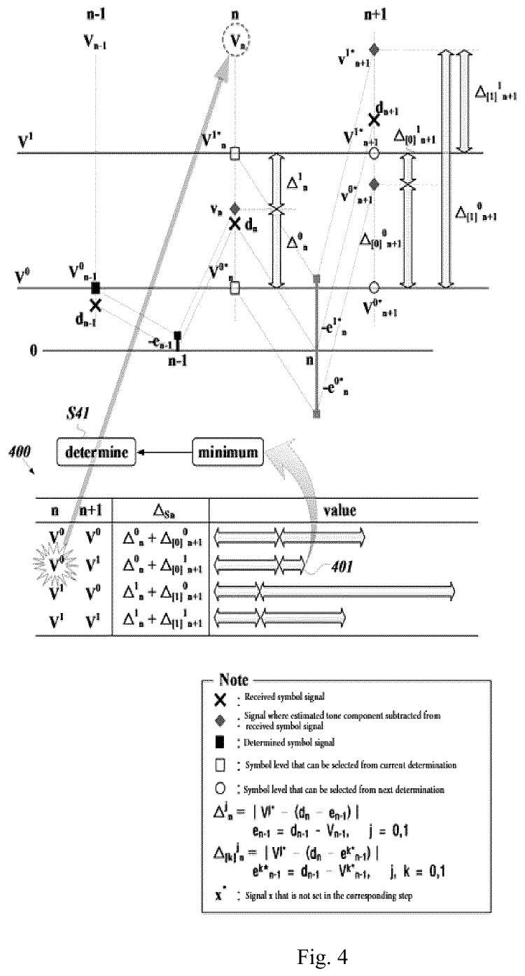

FIG. 4 is a schematic representation of a symbol level determination method based on predicted tones, assuming that a single bit is encoded as a symbol (M=1, L=4) for more intuitive and easier understanding. This drawing shows the process of determining a symbol level Vₙ for the nth reception symbol signal dₙ inputted before a unit time, in a state where the reception symbol signal currently outputted by the equalizer 11 is the (n+1)^{th}. The reception symbol signal for determining the current symbol level is referred to as a ‘target symbol signal’.

Based on the above premise, four error sum calculators are provided, and respective error sum calculators 20ᵢ are configured with a circuit such that one selected among the four combinations (V⁰, V⁰), (V⁰, V¹), (V¹, V⁰), (V¹, V¹) created by two symbol levels V⁰ and V¹ is specified as the current applied symbol level V^{j} and the next applied symbol level V^{k}.

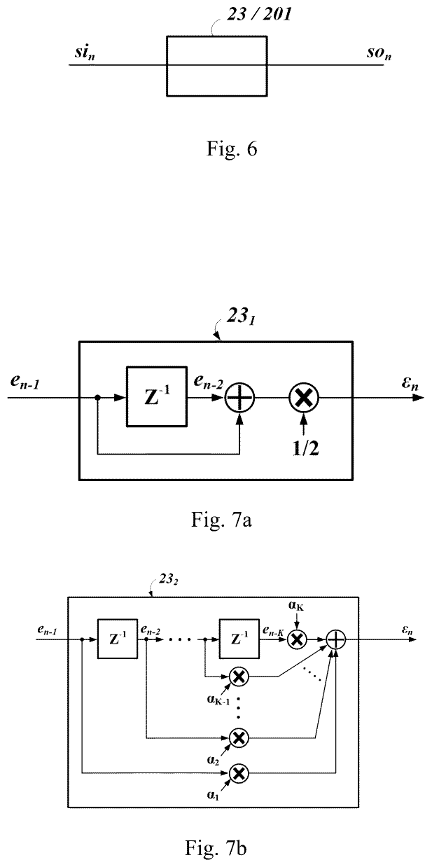

Various configurations for interference value estimation can be applied to the current correlated error filter 23 and the next correlated error filter 201 included in the configuration of the symbol level determinator 100 of FIG. 3. However, in order to easily understand the technical principles and concepts of the present invention, it is assumed that, in the schematic decision process of FIG. 4, a configuration of bypassing the input signal as illustrated in FIG. 6 and outputting it is applied to the current correlated error filter 23 and the next correlated error filter 201 as illustrated in FIG. 6. In this case, the next correlated error filter 201 is configured with an error sum calculator 20ᵢ so that the estimated interference value εₙ outputted from the current correlated error filter 23 is not applied.

According to this assumption, in the reception symbol signal dₙ₋₁ that is earlier than the target symbol signal dₙ by a unit time, the signal from which the determined symbol level Vₙ₋₁ for the signal dₙ₋₁ has been subtracted, i.e., the previous error value eₙ₋₁, is outputted as is as the estimated interference value εₙ, which is the output signal of the current correlated error filter 23. The target symbol signal dn is subtracted from the specified current symbol level V^{j}, that is, the hypothetical error value e^{j}*ₙ predicted on the premise of the symbol level determination of the current symbol level V^{j} is outputted as it is as the conditional interference value ε*ₙ, which is the output signal of the next correlated error filter 201.

Therefore, the signal outputted from the first adder 204 is a signal Vₙ obtained by subtracting the previous error value eₙ₋₁ inputted to the estimated interference value εₙ in the target symbol signal dₙ (this signal is referred to as “interference-compensated signal”), and a current error calculator 202 using this signal as input calculates a current error □^{j}ₙ, which is a next signal between a specified current applied symbol level V^{j} and the inputted interference-compensated signal, to output to the fourth adder 207.

The signal outputted from the third adder 206 is a signal v^{j*}ₙ₊₁ obtained by subtracting the assumed error value (e^{j*}ₙ) predicted on the assumption that the current symbol level V^{j} specified by the error sum calculator 20i is determined in the next reception symbol signal dₙ₊₁ of the target symbol signal dₙ (this signal is referred to as the condition-compensated signal), and the next predicted error calculator 203 using this signal as input calculates the predicted error Δ_{[j]}^{k}ₙ₊₁, which is a next signal between the specified next applied symbol level V^{k} and the condition-compensated signal V^{j*}ₙ₊₁, and outputs it to the fourth adder 207.

The fourth adder 207 adds two next signals, i.e. the current error Δ^{j}ₙ and the predicted error (Δ_{[j]}^{k}ₙ₊₁), provided according to the calculation by the above current correlated error filter 23 and the next correlated error filter 201, and provides the added signal to the level selector 22. The summed next signal is referred to as the ‘bidirectional error sum’.

In accordance with the above-mentioned operation by each error sum calculator 20ᵢ, the bidirectional error sum (Δ^{j}ₙ+Δ_{[j]}^{k}ₙ₊₁, j,k=0,1) provided to the level selector 22 from the respective four error sum calculators 20ᵢ represents the total sum of the differences from the set symbol level when determining the symbol level of each of the target symbol signal dₙ and the next reception symbol signal dₙ₊₁ as (V⁰, V⁰), (V⁰, V¹), (V¹, V⁰), (V¹, V¹), as illustrated in Table 400 of FIG. 4.

Therefore, the level selector 22 compares the magnitudes of the inputted bidirectional error sums with each other, selects the minimum value 401, and determines the current applied symbol level V⁰ specified for the error sum calculator 20ᵢ which outputs the selected value as the symbol level Vₙ for the target symbol signal dₙ (S41).

As specifically explained above, in determining the symbol level for the reception symbol signal at the current point in time, if the error in the symbol level determination for the target symbol signal based on the previous error value confirmed earlier, and the error that may occur in the subsequent reception symbol signal at the time of determining the current symbol level are taken into consideration together, and the symbol level for the target symbol signal is determined, it becomes possible to determine the symbol level that is less affected by the tone components that distort the received symbol signal at the current point in time.

In the example of FIG. 4, if the symbol level of the target symbol signal is determined based only on the interference compensated signal vₙ from which the previous error value has been subtracted, i.e., based only on the current error (Δ^{j}ₙn), the difference (Δ¹ₙ) from the symbol level V¹ is small, so the symbol level is determined to be V¹. However, looking at the next reception symbol signal dₙ₊₁, it can be seen that the tone contains a very large component that biases the transmission signal toward the symbol level V¹. Considering the effects of this interference, determining the symbol level of the target symbol signal as V⁰ rather than V¹ will have a higher probability of matching the transmitted symbol.

The magnitude of the tone added to the reception symbol signal following the target symbol signal that determines the current symbol level is reflected in the predicted error Δ_{[j]}^{k}ₙ₊₁, which is the next signal with the above-mentioned condition-compensated signal Vi*n+1. Therefore, when determining the symbol level of the target symbol signal based on the bidirectional error sums, in the example of FIG. 4, V⁰ other than V¹ is determined as the symbol level of the target symbol signal, and this determination is highly likely to match the transmission symbol.

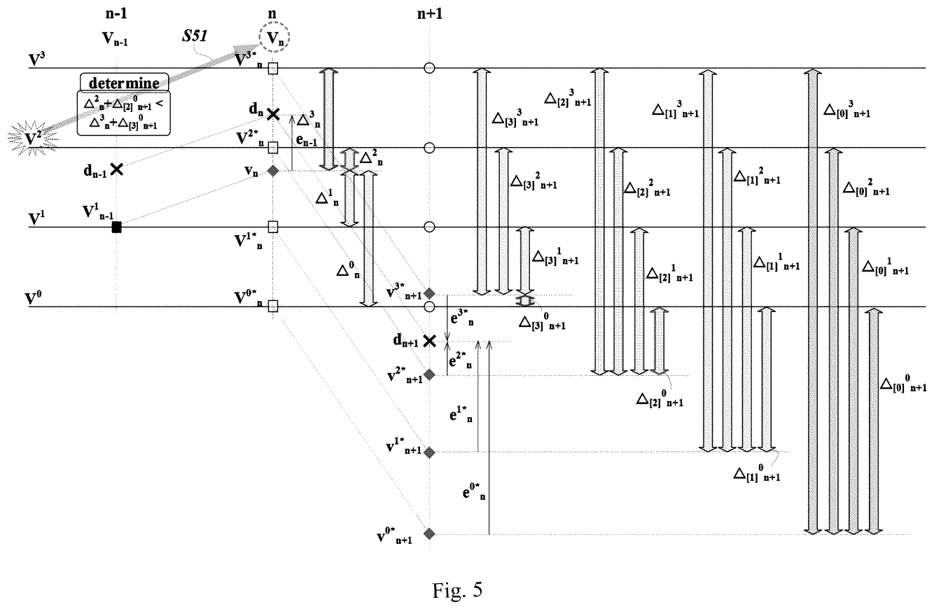

FIG. 5 schematically shows that the symbol level determination method of the present invention is applied to the case of encoding 2 bits as a symbol. The basic principle of the determination method applied to FIG. 5 is the same as the method explained with reference to FIG. 4, and thus, FIG. 5 is illustrated more simply for the sake of simplification of the drawing. In the process of determining the illustrated symbol level, when Vₙ and Vₙ₊₁ are determined as V₂ and V₀, the bidirectional error sum Δ²ₙ+Δ_{[2]}⁰ₙ₊₁ is minimum, the level selection unit 22 then determines the symbol level Vₙ for the target symbol signal to be V² (S51).

In order to facilitate understanding of the technical principles and concepts of the present invention, both correlated error filters 201 and 203 are assumed to be bypass circuits that directly output the inputs illustrated in FIG. 6. However, as mentioned above, the both correlated error filters 201 and 203 may have a different configuration. First, the configuration of another embodiment of the current correlated error filter will be described.

FIG. 7a is a block diagram showing a configuration according to another embodiment of the present invention, in which the current correlated error filter is configured as a filter that averages the inputted error signal eₙ with the previous error signal eₙ₋₁ and outputs it. When the current correlated error filter 23_{I} of FIG. 7a is applied to the symbol level determiner 100 of FIG. 3, the output estimated interference value εₙ becomes (eₙ₋₂+eₙ₋₁)/2. In this way, if the average of two error values is used as the estimated interference value εₙ, a signal that follows the tone component can be created while being relatively less affected by momentary noise.

Instead of a configuration that simply performs arithmetic averaging of the plurality of discrete error signals having unit time differences, as in the filter illustrated in FIG. 7A, the current correlated error filter 232 may be configured with a filter that can perform weighted averaging, as illustrated in FIG. 7b. The current correlated error filter 232 in FIG. 7b includes at least one delay unit (K>2), and is configured to multiply the input error signal eₙ₋ᵢ and the output signal of each delay unit by a weight (aᵢ, i=1, . . . ,K) assigned to the corresponding signal in each multiplier, and then add them in an adder to output an estimated interference value εₙ.

Each of the weights αᵢ may be a fixed constant as circuits. For example, assuming that the error is 3, α₁, α₂ and α₃ may all be ⅓, or ½, ⅓, and ⅙, respectively. Alternatively, they may be dynamic constants that are adaptively set in accordance with the characteristics of the tone. This will be described later.

Next, the configuration of another embodiment of the next correlated error filter 201 will be described.

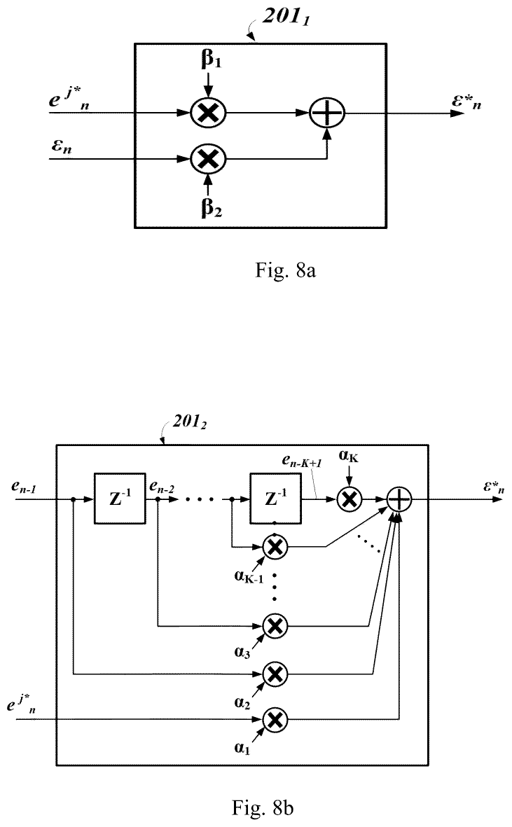

FIG. 8a shows a next correlated error filter 201₁ configured as a filter that can output a conditional interference value ε*ₙ by weighting the estimated interference value εₙ and the hypothetical error value e^{j*}ₙ. The weights β₁ and β₂ used in this filter may also be constants that are fixed as circuits or constants that are dynamically determined and applied.

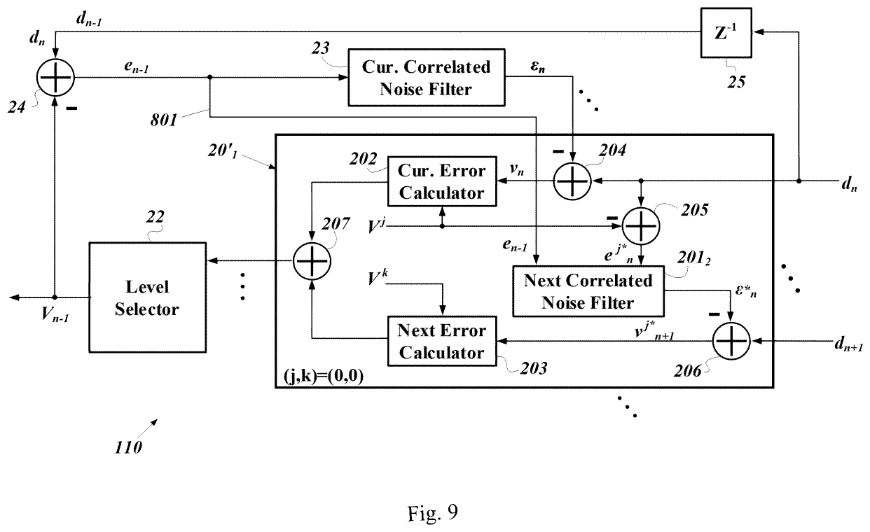

In another embodiment according to the present invention, the next correlated error filter can be configured such that the error signal eₙ₋₁ is inputted instead of the estimated interference value εₙ that is the output of the current correlated error filter. That is, the symbol level determiner 100 of FIG. 3 may be configured as illustrated in FIG. 9. As illustrated in FIG. 9, the next correlated error filter 201₂ that receives input of the error signal eₙ₋₁ 801 may be configured as illustrated in FIG. 8b, and in this case, the current correlated error filter be preferably configured as a filter as illustrated in FIG. 7b.

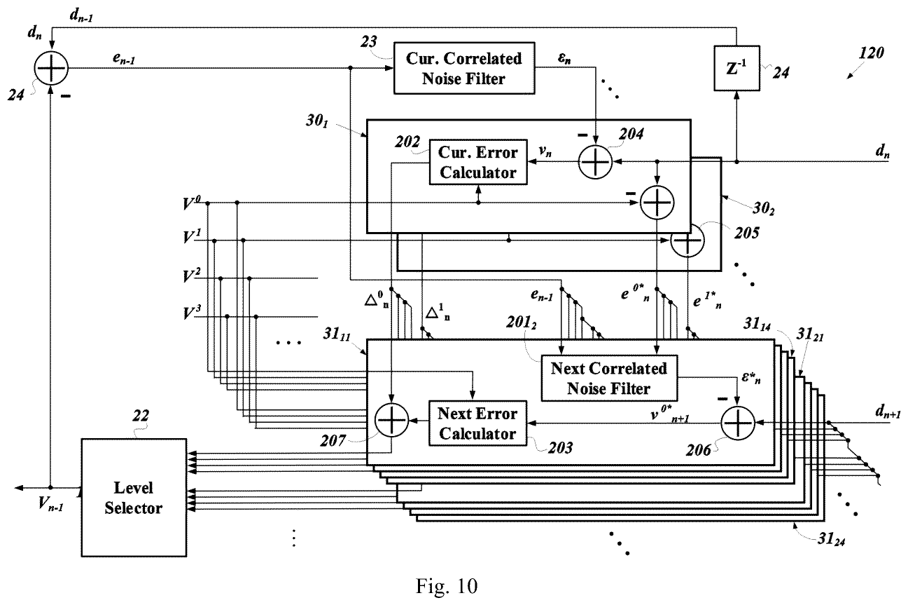

In another embodiment according to the present invention, the error sum calculator may be configured separately as a current error calculator and a predicted error calculator. The block diagram of FIG. 10 shows a symbol level determiner 120 configured according to the present embodiment, which is configured on the premise of encoding 2 bits as a symbol. In the symbol level determiner 120 of the present embodiment, a current error calculator (30ᵢ, i=1,2, . . . ) is provided for each symbol level, and a predicted error calculator (31ᵢⱼ, j=1, . . . , 4) for the number of symbol levels is provided per one current error calculator 30ᵢ.

The assumed error value (e^{i*}ₙ, i=0, 1, . . . ) outputted from each current error calculator 30ᵢ and the calculated current error (□ⁱₙ, i=0, 1, . . . ) are configured to be commonly applied to the next correlated error filter 201₂ and the fourth adder 207 of the corresponding four predicted error calculators 31ᵢⱼ, respectively.

As illustrated in FIG. 10, the embodiment in which the error sum calculator is

divided into the current error calculator and the predicted error calculator can also be applied to the symbol level determiner 100 of the configuration illustrated in FIG. 3.

Meanwhile, the next correlated error filter 201₂ of FIG. 8b is configured to include one less delay unit than the current correlated error filter 23₂ of FIG. 7b, and the weights applied to each multiplier may be the same as the weights applied to each of the multipliers of FIG. 7b. Since the number of the delay unit is one less, the number of discrete error signals to be multiplied is also one less than the current correlated error filter 232, and these multiplications are sequentially applied with weights (αᵢ, i=2, 3, . . . ) excluding the weight α₁ applied to the multiplication of the current discrete error signal eₙ₋₁ in the current correlated error filter 232, and the excluded weight α₁ is configured to be applied to the multiplication of the inputted hypothetical error value e^{j*}ₙ.

The current correlated error filter is a filter as illustrated in FIG. 7b, and when the next correlated error filter is configured as a filter as illustrated in FIG. 8b, in one embodiment according to the present invention, a symbol level determiner may be configured so that the weights of the corresponding filter can be dynamically set in accordance with the characteristics of the error signal. FIG. 11 illustrates only the relevant components of the symbol level determiner according to the present embodiment, and the present embodiment further includes a filter controller 40.

The filter controller 40 checks the fluctuation rate of a series of discrete error signals outputted from the main adder 24, and if the fluctuation rate (which corresponds to the fluctuation rate of the tone) is high, it selects a weight set which is set to be applied in the case of a high fluctuation rate from the weight sets provided, and sets it to the current correlated error filter 232 and the next correlated error filter 201₂. The weight set which is set to be applied in the case of a high fluctuation rate is a set in which a weight applied to an error signal of a relatively more past time is specified as a low value (A weight applied to an error signal of a relatively more present time is specified as a high value.)

For example, for the correlated error filters illustrated in FIGS. 7b and 8b, assuming that K is 3 and a set of weights in which α₁, α₂ and α₃ are each specified as ⅓ are initially set for the correlated error filters 23₂, 201₂, if the fluctuation rate observed for the discrete error signal is higher than a predetermined reference value, the filter controller 40 resets the weight set in which ⅔, ⅓, and 0 are specified for the correlated error filters 232 and, 2012.

According to an embodiment of the present invention, the fluctuation rate of the error signal may be divided into a larger number of sections, and weight sets specified for the divided sections may be applied to the filter controller 40 to be used for dynamic weight setting for the correlated error filters 23₂ and 201₂.

In the embodiments described so far, a symbol signal obtained by delaying the current reception symbol signal by a unit time is used as the target symbol signal for determining the current symbol level. However, the technical principle and concept of the present invention are not limited to using a symbol signal delayed by one unit time as the target symbol signal. In other words, after the reception symbol signal is delayed by two or more units of time, the symbol level can be determined by checking the effects of the tone that distorted the reception symbol signal even after the two-unit time.

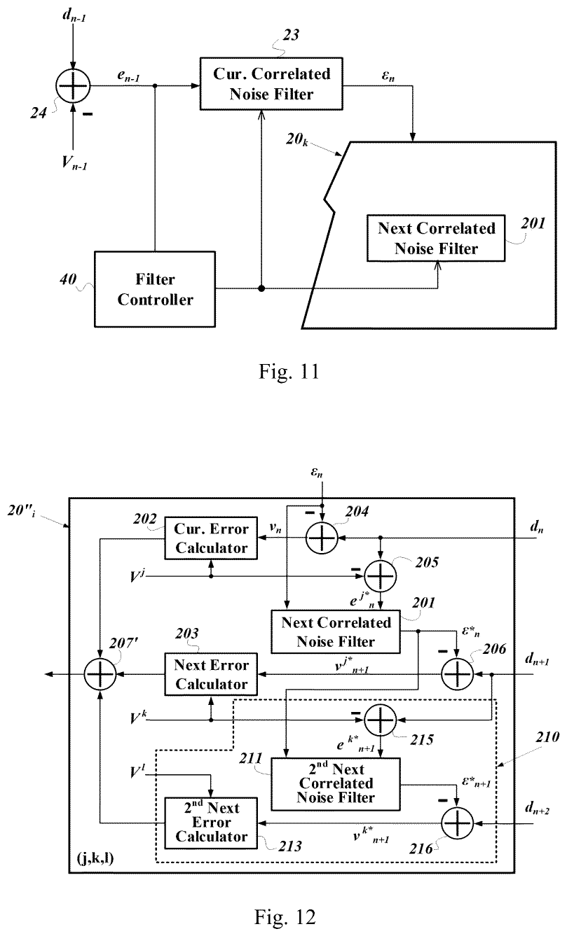

FIG. 12 is a block diagram of an error sum calculator 20″ᵢ configured for this embodiment, which checks the tone influence of discrete reception symbol signals up to two unit times to determine the symbol level. The following description with reference to FIGS. 12 to 15 shows a method of determining a conditional interference value (ε*ᵢ, i=n,n+1) on the discrete reception symbol signal excluding the latest discrete reception symbol signal dₙ₊₂ from the series of discrete reception symbol signals after the target symbol signal and the target symbol signal, and calculating a predicted error from this conditional interference value ε*ᵢ and the series of discrete reception symbol signals. From this explanation, an embodiment that extends the presented method to subsequent discrete reception symbol signals can be sufficiently derived.

The error sum calculator 20″ᵢ of FIG. 12 is provided with (2^{M})³ (M is the number of bits encoded as one symbol), and receives input of the target symbol signal dₙ and the subsequent continuous discrete reception symbol signals dₙ₊₁ and dₙ₊₂. In addition, delay units corresponding to the number of signals are connected in a chain manner to each other and connected to the output terminal of the equalizer 11 so that continuous discrete reception symbol signals dₙ₊₁ and dₙ₊₂ can be obtained.

Comparing the configuration of the error sum calculator 20″ᵢ with the error sum calculator 20ᵢ of FIG. 3, it is different in that it further includes a part 210 for calculating a next predicted error, and the fourth adder 207′ is configured to add three errors, i.e., a current error, a predicted error, and a next predicted error. The part 210 for calculating the next predicted error includes fifth and sixth adders 215 and 216, a second correlated error filter 211, and a next predicted error calculator 213, which operate in the same manner as in the parts 205, 206, 201 and 203 for calculating predicted errors, except that they input the next discrete reception symbol signal dₙ₊₂ and the next conditional interference value ε*ₙ₊₁, instead of the next reception symbol signal dₙ₊₁ (hereinafter referred to as the “next symbol signal”) of the target symbol signal and the estimated interference value εₙ.

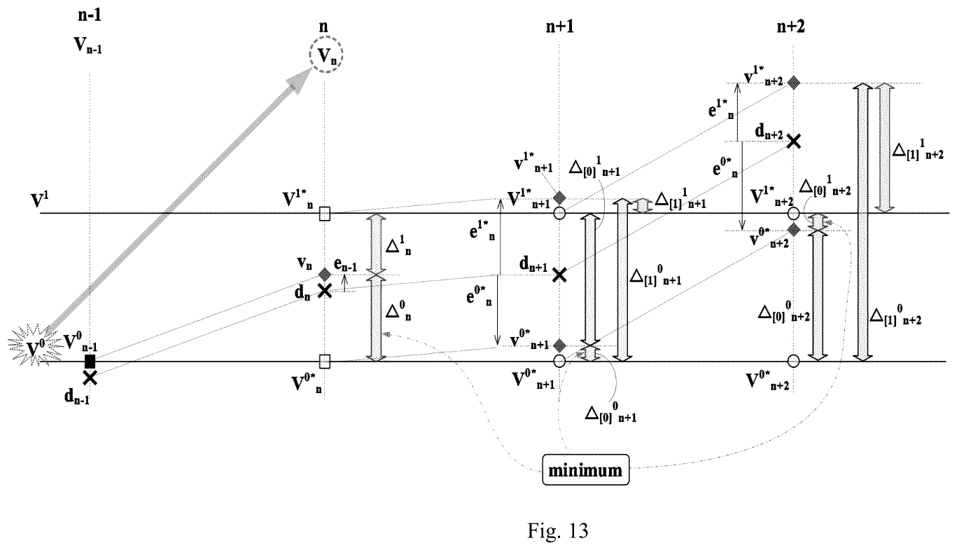

FIG. 13 is an example of a bidirectional error sum obtained by an error sum calculator 20″ᵢ configured as illustrated in FIG. 12, which assumes that 1 bit is encoded as a symbol and that all correlated error filters are configured to bypass the input signal to the output as in FIG. 6.

As illustrated in FIG. 13, in determining the symbol level for the target symbol signal dₙ, not only the predicted error (Δ_{[j]}^{k}ₙ₊₁, j,k=0,1), but also the next predicted error (Δ_{[k]}¹ₙ₊₂, k,l=0,1) that appears in the next reception symbol signal dₙ₊₂ (hereinafter referred to as the ‘next symbol signal’) when the symbol level for the next symbol signal dₙ₊₁ is determined is also reflected in the error sum and determined. The illustrated drawing shows that if the symbol level is determined by reflecting only the current error and predicted error in the bidirectional error sum, then if both Vₙ and Vₙ₊₁ are 1, the bidirectional error sum Δ¹ₙ+Δ_{[1]}¹ₙ₊₁ is minimum, and thus, the symbol level of the target symbol signal dₙ is determined as V_{I}, but if the next predicted error is reflected in the bidirectional error sum, the bidirectional error sum (Δ⁰ₙ+Δ_{[0]}⁰ₙ₊₁+Δ_{[0]}¹ₙ₊₂) is minimum, if Vₙ, Vₙ₊₁, and Vₙ₊₂ are V₀, V₀ and V₁, showing that the symbol level of the target symbol signal dₙ is determined as V⁰.

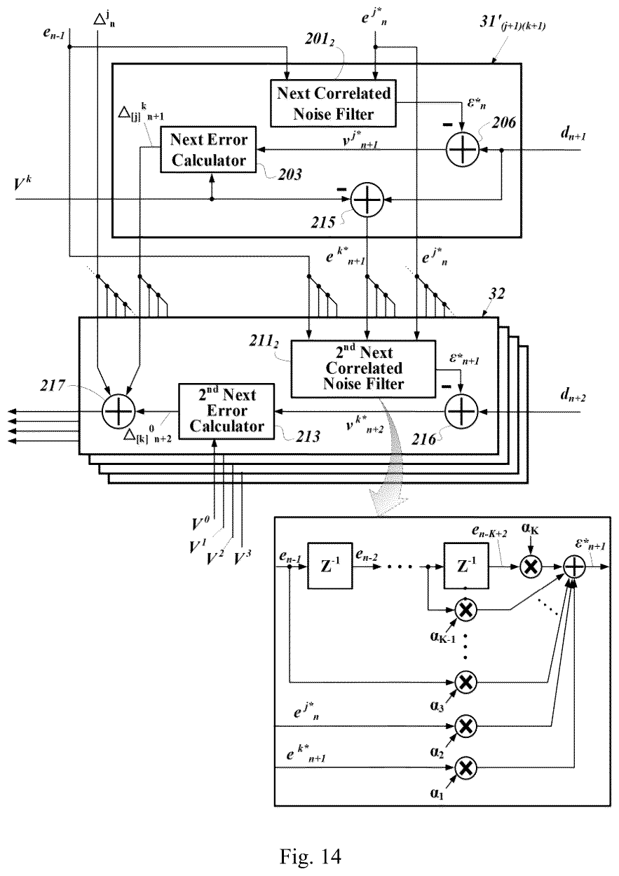

An embodiment in which the error sum calculator is divided into a current error calculator and a predicted error calculator can also be configured to determine the symbol level by reflecting up to the next predicted error in the bidirectional error sum. FIG. 14 is an example of components that have differences in the configuration of the error sum calculator when the symbol level determiner 120 of FIG. 10 is changed to determine the symbol level by reflecting the next predicted error, which illustrates one predicted error calculator 31′₍ⱼ₊₁₎₍ₖ₊₁₎ and four next predicted error calculators 32 that are provided corresponding to it and each receive a signal output therefrom.

Compared with the predicted error calculator 31₁₁ of FIG. 10, the predicted error calculator 31′₍ⱼ₊ᵢ₎₍ₖ₊ₙ₎ of FIG. 14 includes a fifth adder 215 in which a fourth adder 207 is removed, and instead the symbol level V^{k} assigned to the calculator is subtracted from the next symbol signal dₙ₊₁ to output the next conditional interference value e^{k*}ₙ₊₁.

The next predicted error calculator 32 includes a second correlated error filter 211₂ that receives input of an error signal eₙ₋₁, an assumed error value e^{j*}ₙ, and a next assumed error value e^{k*}ₙ₊₁ and outputs a next conditional interference value ε*ₙ₊₁, a sixth adder 216 that subtracts the conditional interference value ε*ₙ₊₁ from the inputted next symbol signal dₙ₊₂ and outputs it, a next predicted error calculator 213 that outputs a next predicted error (Δ_{[k]}¹ₙ₊₂) corresponding to the difference between the symbol level applied to the corresponding calculation section and the output signal of the sixth adder 216, and a seventh adder 217 in which the current error and the predicted error which are output from the current error calculator 202 and the predicted error calculator 203 of the hierarchically corresponding current error calculator and the predicted error calculator 31′₍ⱼ₊₁₎₍ₖ₊₁₎. and the next predicted error outputted by a next predicted error calculator 213, are all added up to output them to the level selector 22.

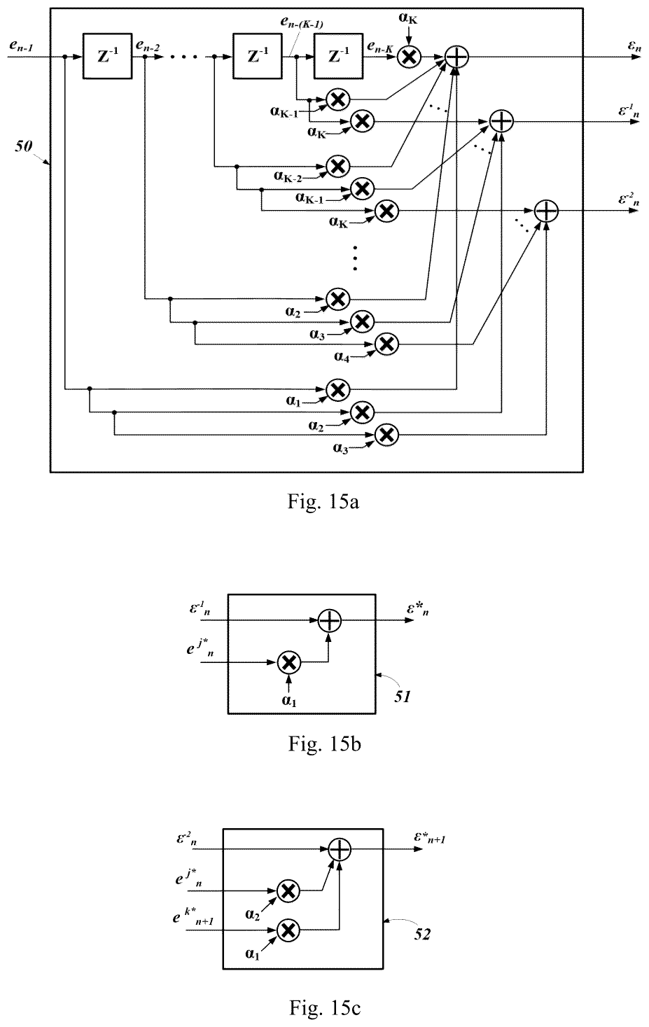

In one embodiment of the present invention, the symbol level determiner is configured to commonly use the circuit elements of the correlated error filters, thereby being able to reducing the circuit elements included in the error sum calculator, the current error calculator, the predicted error calculator, or the next predicted error calculator. FIGS. 15a to 15c are block diagrams illustrating components related to the correlation error filter configured according to the present embodiment.

FIG. 15a is a block diagram showing the configuration of a filter root 50 including, in addition to the components of the current correlated error filter 232, a component for producing weighted average error values e⁻¹ₙ and e⁻²ₙ required for generating a conditional interference value ε*ₙ. This filter root 50 is included as a replacement for the current correlated error filter 23 of the symbol level determiners 110 and 120 whose configuration is illustrated in FIGS. 9 and 10.

And, for the error sum calculator 20′ᵢ of FIG. 9 and the predicted error calculators 31ᵢⱼ, 31′₍ⱼ₊₁₎₍ₖ₊ₙ₎ of FIGS. 10 and 14, the second correlated error filter 201₂ is replaced with the first filter leaf 51 whose configuration is illustrated in FIG. 15b, and for the second correlated error filter 211₂ of the predicted error calculator 32 of FIG. 14, the second filter leaf 52 whose configuration is illustrated in FIG. 15c is replaced to form the symbol level determiner.

Meanwhile, in the above-mentioned embodiments, when obtaining the bidirectional error sum, each error to be summed, i.e., the current error and the predicted error (depending on the embodiment, including the N^{th} predicted error obtained for the subsequent reception symbol signals, N>1), is given a weighting value, can be added. In assigning weights to these, the error calculated for the signal that is temporally closer to the reception symbol signal that determines the current symbol level can be assigned a greater weight.

The various embodiments of the method for determining a symbol signal based on the predicted error due to narrowband interference according to the present invention and the equipment for the method, which have been specifically described so far, and the configurations and actions described in the embodiments, can be selectively combined with each other in various ways, except for the cases where they are mutually incompatible.

The above-mentioned embodiments of the present invention have been disclosed for illustrative purposes, and those skilled in the art will appreciate that various improvements, modifications, substitutions or additions can be made in the embodiments without departing from the technical spirit and scope of the present invention disclosed in the appended claims.

### DESCRIPTION OF REFERENCE NUMERALS

10: Tone removal unit
11: Equalizer
12: Slicer
13: Error filter
20i, 20′ᵢ: Error sum calculator
21: First delay unit
22: Level selector
23, 23₁, 23₂: Current correlated error filter
24: Main adder
25: Second delay unit
30i: Current error calculator
31i, 31′ᵢⱼ: Predicted error calculator
32: Next predicted error calculator
40: Filter controller
50: Filter root
51: First filter leaf
52: Second filter leaf
100,110, 120: Symbol level determiner
201,201₁,201₂: Next correlated error filter
202: Current error calculator
203: Predicted error calculator
204: First adder
205: Second adder
206: Third adder
207,207′: Fourth adder
215: Fifth adder
216: Sixth adder
211,211₂: Second correlated error filter
213: Next predicted error calculator
215, 216: Adder
217: Seventh adder

1. A device that determines the level of symbol signals received and equalized through a transmission channel, the device comprising:
one or more delay units connected in a chain to each other, each delaying the equalized symbol signals by a unit time and outputting the delayed signals;
a determiner configured such that the symbol level for the current symbol signal inputted from a final stage delay unit of the one or more delay units is determined as one of the predetermined symbol levels at which a minimum error sum is obtained from possible error sums of a current error calculated for the current symbol signal and a predicted error calculated for one or more next discrete symbol signals following the current symbol signal,
wherein the current error is a difference value between the current symbol signal and the specified symbol level of the compensated first signal, and the predicted error is a difference value between the predetermined symbol level of the compensated second signal and each of one or more next discrete symbol signals, and
wherein the second signal is determined at each of the predetermined symbol levels with respect to the symbol signal just before the corresponding next discrete symbol signal.

2. The device according to claim 1, wherein the determiner comprises,
a plurality of calculators configured such that a number (=L^{N}) of current errors corresponding to the N power of the number L of predetermined symbol levels are added to the predicted error to output one of the possible error sums, and
a selector configured such that the possible error sums outputted from each of the plurality of calculators are compared with each other to select one from the predetermined symbol levels,
N is the number of one or more next discrete symbol signals plus 1, and
in each of the plurality of calculators, the N specified symbol levels belonging to one of the symbol level combinations created by selecting the already specified symbol levels N times are used in calculating the current error and the predicted error.

3. The device according to claim 2, wherein the calculators are configured such that a first compensation value used for compensating the current symbol signal to obtain a first signal is used to obtain the second compensation value used for compensating the one or more next discrete symbol signals to obtain a second signal.

4. The device according to claim 2, wherein the calculators are configured such that the first compensation value used for compensating the current symbol signal to obtain the first signal, and the second compensation value used for compensating the one or more next discrete symbol signals to obtain the second signal are obtained from one or more discrete difference values corresponding to the difference from the determined symbol level of one or more discrete symbol signals inputted before the current symbol signal.

5. The device according to claim 4, wherein the calculators are configured such that the second compensation value is calculated from a partial discrete difference value excluding the current difference value from the one or more discrete difference values used to obtain the first compensation value, and a current difference value obtained by subtracting one of the specified symbol levels from the current symbol signal.

6. The device according to claim 5, wherein the calculators are configured such that the first compensation value is calculated from a weighted average of the one or more discrete difference values, and the second compensation value is calculated from a weighted average of the partial discrete difference values and the current difference value, wherein the weight applied to the current difference value and the weight applied to the current difference value are the same.

7. The device according to claim 1, wherein the determiner comprises,
a plurality of first error calculators configured to calculate the current error, each of which is provided in the same number as the number L of the specified symbol levels,
a plurality of second error calculators configured such that the L number of predicted errors provided corresponding to each of the first error calculators are calculated, and the predicted errors are added to the current errors calculated by the corresponding first error calculators to output one of the possible error sums, and
a selector configured such that the possible error sums outputted from each of the calculators are compared with each other to select one from the predetermined symbol levels,
wherein in each of the first error calculators and the second error calculators, one symbol level of the specified symbol levels is used for calculating the current error or the predicted error.

8. The device according to claim 7, wherein the determiner further comprises a plurality of third error calculators configured such that the L number of second error calculators are provided corresponding to the second error calculators, and each of the L units generates another predicted error and adds the current error and predicted error calculated by the first error calculator and the second error calculator which correspond hierarchically, to output one of possible error sums.

9. The device according to claim 1, wherein the determiner is configured such that a difference value between the current symbol signal and one of the predetermined symbol levels is used to obtain a second compensation value for use in compensating one or more next discrete symbol signals to obtain a second signal.

10. The device according to claim 1, wherein the compensation comprises canceling, for each of one or more discrete symbol signals inputted before a compensation target symbol signal, an interference component obtained from a difference value between the corresponding discrete symbol signal and a specified symbol level determined for the corresponding discrete symbol signal, from the compensation target symbol signal.

11. The device according to claim 10, wherein the determiner is configured to apply a weighted average obtained by individually applying weights to one or more of the difference values as the interference component.

12. The device according to claim 11, wherein the determiner further comprises a controller configured to check the fluctuation rate of the difference value and change and apply the weight according to the checked fluctuation rate, and
the controller is further configured to change the weight applied to the difference value obtained for the discrete symbol signal just before the compensation target symbol signal to a higher value when the fluctuation rate is high compared to when the fluctuation rate is low.

13. The device according to claim 1, wherein the determiner is further configured to multiply the current error by the weights respectively assigned to the one or more predicted errors to obtain a sum, wherein the weights are assigned relatively larger values as they are multiplied by the error obtained for a discrete symbol signal that is closer in time to the current symbol signal.

14. The device according to claim 1, wherein the determiner comprises,
a single filter root including at least one delay unit, which is configured to receive input of a difference value from a specified symbol level determined for each of one or more discrete symbol signals inputted before the current symbol signal, and configured to output a first compensation value used for compensating the current symbol signal to obtain the first signal,
a plurality of filter leaves configured to obtain a second compensation value used for compensating the one or more difference discrete symbol signals to obtain the second signal,
wherein the filter root is configured to multiply a series of discrete difference values generated by the at least one delay unit by each of the assigned sets of weights, and output a plurality of weighted sum values including the first compensation value,
wherein the plurality of filter leaves are configured such that at least one signal, which is obtained by subtracting one of the predetermined symbol levels from the next discrete symbol signal excluding the current next discrete symbol signal from the one or more next discrete symbol signals, and at least one symbol signal selected from the current symbol signal, and one of the weighted sum values excluding the first compensation value among the plurality of weighted sum values is weighted and summed, and outputted as the second compensation value.

15. A method for determining a level of a symbol signal received and equalized through a transmission channel, the method comprising:
a step of delaying an equalized symbol signal by a unit time,
a step of calculating possible error sums for the current error calculated for the delayed symbol signal and the predicted error calculated for the delayed one or more next discrete symbol signals after the delayed symbol signal, with respect to the symbol level of the delayed symbol signal, and
a step of determining one of the predetermined symbol levels, from which the minimum error sum is obtained from the calculated possible error sums, as the symbol level of the delayed symbol signal,
wherein the current errors are respective difference values between the first signal compensated for the delayed symbol signal and the specified symbol levels, and the specified errors are difference values between the second signal compensated for each of the one or more next discrete symbol signals and the specified symbol levels, and
the specified second signals are a plurality of signals created by determining the symbol signal just before the next discrete symbol signal as each of the specified symbol levels.
